(19) United States
(12) Patent Application Publication
(10) Pub. No.: US 2014/0115126 A1
(43) Pub. Date: Apr. 24, 2014

(54) SYSTEM FOR CONTROLLING AND VERIFYING OPEN PROGRAMMABLE NETWORK AND METHOD THEREOF

(71) Applicant: ELECTRONICS AND TELECOMMUNICATIONS RESEARCH INSTITUTE, Daejeon (KR)

(72) Inventors: Ki-Hyuk NAM, Daejeon (KR); Myung Ki SHIN, Seoul (KR); Hyoung Jun KIM, Daejeon (KR); Jin Ho HAHM, Daejeon (KR)

(73) Assignee: ELECTRONICS AND TELECOMMUNICATIONS RESEARCH INSTITUTE, Daejeon (KR)

(21) Appl. No.: 14/057,846

(22) Filed: Oct. 18, 2013

(30) Foreign Application Priority Data
Oct. 19, 2012 (KR) 10-2012-0116773
Oct. 4, 2013 (KR) 10-2013-0118711

(51) Int. Cl. H04L 12/24

(52) U.S. Cl. CPC H04L 41/0866
USPC 709/220

(57) ABSTRACT

In a network environment in which pieces of heterogeneous network equipment interwork, a system receives a request including configuration information regarding a network operation with respect to at least one piece of a network equipment. The system verifies whether the request is in conflict with a network configuration and property managed by the system, and when an error does not occur according to verification results, the system transfers the verification results including configuration information to the network equipment.

### CROSS-REFERENCE TO RELATED APPLICATION

This application claims priority to and the benefit of Korean Patent Application No. 10-2012-0116773 and 10-2013-0118711 filed in the Korean Intellectual Property Office on Oct. 19, 2012 and Oct. 4, 2013, the entire contents of which are incorporated herein by reference.

### BACKGROUND OF THE INVENTION

(a) Field of the Invention

The present invention relates to network control and verification, and more particularly, to a system for controlling and verifying an open programmable network and a method thereof.

(b) Description of the Related Art

In network equipment such as a network switch, generally, a data plane for implementing various network protocols and a control plane for setting up and controlling such equipment are provided as a single system.

In recently emerging software defined network, a control plane and a data plane of equipment are separated and an open interface is defined therebetween, thereby allowing heterogeneous equipment to interwork and providing a passage for arbitrarily defining an operation of a data plane. Such a technology is a software defined networking (SDN) technology such as an open flow (OpenFlow), according to which network equipment is controlled by a separate module in a centralized manner according to an open interface and a standard protocol. In this case, an existing function such as forwarding (i.e., packet transmission) is executed by network equipment, while functions to be determined from a perspective of an overall network are executed by a module separately positioned in the center.

According to the SDN technology, heterogeneous equipment may smoothly interwork, allowing for innovation of a fast networking technique, and thus the SDN technology has been actively applied to various environments including a data center, the cloud, and the like.

However, apart from the advantages of the networking technology having an open structure, when a network has a large scale or in a process of defining a novel function including complicated operations, an unintentional error may occur to lead to a fault of a network itself.

### SUMMARY OF THE INVENTION

The present invention has been made in an effort to provide a system for controlling and verifying a network having advantages of reliably verifying a network operating in an environment in which heterogeneous equipment interwork through an open interface, and a method thereof.

An exemplary embodiment of the present invention provides a method for verifying a network operation by a system in a network environment in which heterogeneous types of network equipment interwork, including: receiving, by the system, a request including network operation-related configuration information regarding at least one piece of network equipment included in a single domain, in a state in which the network equipment is managed by a domain; verifying, by the system, whether the request is in conflict with a network configuration and property managed by the system; and when an error has not occurred according to the verification results, transferring the verification results including the configuration information to the network equipment.

In the receiving, the request may be received from an application of a higher layer or an external network operation system (NOS), and in the transferring, the verification results may be transferred to the application unit or the external NOS.

The method may further include: translating the input request into a configuration form for verification before the verifying; and translating the verification results into a form that is processable in the application unit or the external NOS before the transferring.

The configuration information may be information regarding a software defined network (SDN) to control network equipment included in the domain by the application unit of the higher layer or the external NOS, and the SDN may be one of a plurality of virtual networks obtained by classifying a physical network to which pieces of network equipments are connected, by slice.

The method may further include: allocating the input received by one of the plurality of virtual networks so that the corresponding request can be processed on the basis of a slice ID corresponding to the virtual network to which the request was allocated, after the receiving.

In the verifying, the configuration information may include match-action rules with respect to network equipment included in a domain related to the SDN and information regarding a structure of the SDN. The verifying may include verifying whether inter-contradiction exists between the rules, or whether an infinite loop or a black hole is generated in the structure of the SDN.

The verifying may further include: when the request includes property information in addition to the configuration information, verifying whether the configuration information satisfies the property information.

The verifying may further include verifying whether the configuration information satisfies property information previously set by the system.

In the verifying, the configuration information may be verified in consideration of information regarding networks managed by the system and state information regarding the networks.

Another embodiment of the present invention provides a system for controlling and verifying networks in which pieces of heterogeneous network equipment interwork, including: a control device configured to manage the network equipment by domain, classify a physical network to which network equipment is connected into a plurality of virtual networks by slice and manage the same, and control an operation of each piece of network equipment; and a reliability checking device configured to receive configuration information regarding a network operation with respect to at least one piece of network equipment included in a single domain and verify whether the request is in conflict with a network configuration and property managed by the control device, wherein the request is input from an application unit of a higher layer or an external network operation system (NOS).

The control device may include: a verifying unit configured to verify whether the request is in conflict with a network configuration and property managed by the control device; and a translation unit configured to translate the request into a configuration form for verification, provide the same to the verifying unit, and translate verification results from the verifying unit into a form based on an interface corresponding to the application unit or the external NOS.

The control device may further include: a slice management unit configured to allocate the request to one of a plurality of virtual networks so that the corresponding request can be processed on the basis of a slice ID corresponding to the virtual network to which the request was allocated; and a network database configured to store information regarding a network state and a network equipment state managed by the control device, the information including at least one of topology information, link state information, and a flow rule. The information stored in the network database may be matched to the slice ID corresponding to the virtual network and a domain ID with respect to network equipment related to the corresponding virtual network.

At least one of the reliability checking device and the verifying unit may operate as a verifying device, wherein when the configuration information includes match-action rules with respect to network equipment included in a domain related to a software defined network (SDN) and information regarding a structure of the SDN, the verifying device may verify whether intra-contradiction exists between the rules or whether an infinite loop or a black hole is generated in the structure of the SDN.

When the request includes property information in addition to the configuration information, the verifying device may additionally verify whether the configuration information satisfies the property information.

The verifying device may include a property library storing property information previously set by the system, and may additionally verify whether the configuration information satisfies the property information previously set by the system.

### BRIEF DESCRIPTION OF THE DRAWINGS

FIG. 1 is a view illustrating a structure of a system for controlling and verifying a network according to an embodiment of the present invention.

FIG. 2 is a view illustrating an environment in which the system for controlling and verifying a network according to an embodiment of the present invention manages a network.

FIG. 3 is a view illustrating an information format stored in a network database according to an embodiment of the present invention.

FIG. 4 is a view structurally illustrating operations of a reliability checking device and a verifying unit performing a verification process in the system for controlling and verifying a network according to an embodiment of the present invention.

FIG. 5 is a flowchart illustrating a verification method according to an embodiment of the present invention.

FIG. 6 is a view illustrating operations of the reliability checking device and the verifying unit in performing the verification method according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a system for controlling and verifying a network and a method thereof according to an embodiment of the present invention will be described.

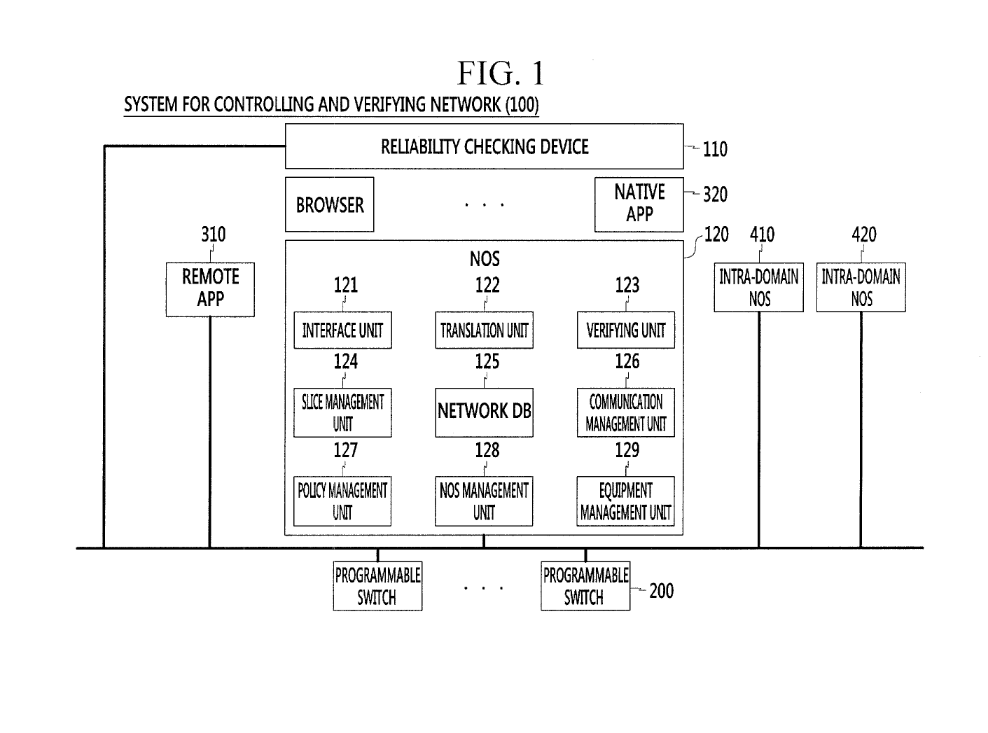

FIG. 1 is a view illustrating a structure of a system for controlling and verifying a network according to an embodiment of the present invention.

As illustrated in FIG. 1, the system for controlling and verifying a network according to an embodiment of the present invention are connected to a plurality of pieces of network equipment (denoted by “200”), and includes a reliability checking device 110 and a control device 120.

Each piece of network equipment 200 may also be referred to as a programmable switch, and may be able to add or delete functions of L3 or higher, as well as an existing L2 switch function through programming. Here, each piece of network equipment 200 communicates with a different module through a network, and in general, an existing Internet/Intranet may be used, and according to circumstances, a defined communication technique may be employed.

Functions and various service applications that may be controlled through the network equipment, i.e., the programmable switch 200, are denoted by application units (APPs), the application units range from a simple learning switch to a firewall, and load balancing may exist. The application units may be divided into a remote application unit (Remote App) 310 and a native application unit (Native App) 320, and the remote application unit is an application using a network function in a remote procedure call manner on the basis of a standard such as REST API, or the like, rather than being operated directly on the control device 120 handling a function of a control plane. In comparison, the native application unit directly interworks with the control device 120, and an implementation language thereof is subordinate to the control device 120. Such applications units may perform the same functions, except for the interworking scheme.

Meanwhile, the control device 120 may be referred to as a network OS (NOS). Hereinafter, the control device 120 will be referred to as “NOS”. The NOS 120 controls pieces of network equipment 200, and connect the application units of a higher layer and the programmable switches as lower layer devices.

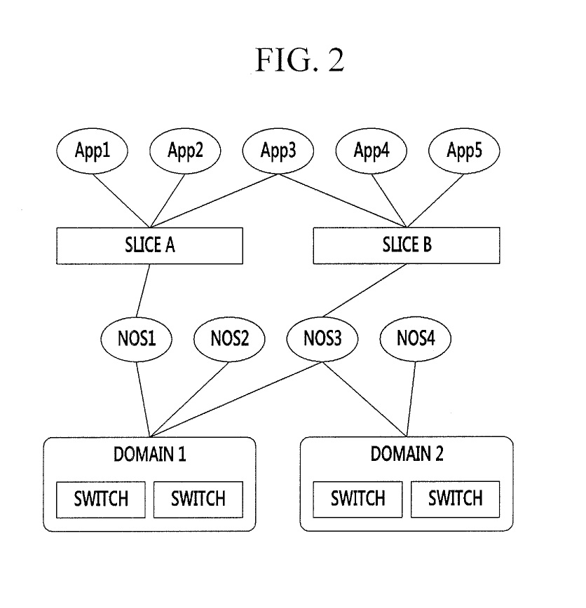

FIG. 2 is a view illustrating an environment in which the system for controlling and verifying a network according to an embodiment of the present invention manages a network.

An actual physical network and pieces of network equipment connected thereto are batched by domain to be managed. Here, a domain is a unit for managing a physical network and network equipment on the basis of a management subject and a policy.

Such a physical network and network equipment are controlled by the NOS, and, for example, a single NOS (NOS1, NOS2, or NOS4 in FIG. 2) provides a function for several applications to a single domain. However, a single NOS, such as NOS3, may provide a function for several applications to several domains. In order to provide a function, a domain verification and interworking process should be performed, and this will be described in detail below.

Meanwhile, in FIG. 2, NOS1 and NOS2 are set as control devices for managing a domain 1, and when NOS1 has a fault, NOS2 may be set to substitute for NOS1, and NOS1 and NOS2 may divide network equipment and network control requests of a domain 1 in a particular ratio to process them.

Each NOS serves as an OF for application units, but in many cases, each NOS configures an actual physical network as a plurality of virtual networks and manages the virtual networks in a 1:n manner, rather than managing the physical network in a 1:1 manner. In particular, an experimental network such as the cloud, a data center, and a global environment for network innovation (GENI) configured on the basis of a virtualization technology may manage networks in the foregoing manner.

In an embodiment of the present invention, a single physical network is divided into several virtual networks to provide the same by using the network virtualization technology. A physical network is divided into a plurality of virtual networks in units of a slice (or by slice) to provide an independent and logical network view to a user or an application unit.

In FIG. 2, although a slice A and a slice B, virtual networks, use the same physical network and physical devices, they are not interfered with when an actual application unit performs calculation. The reliability checking device 110 and the verifying unit 123 according to an embodiment of the present invention basically check properties independently performed without interference to not cause interference with different slices.

In such a network environment, the system 100 for controlling and verifying a network has the following structure.

As illustrated in FIG. 1, the NOS 120 as a control device of the system 100 for controlling and verifying a network includes an interface unit 121, a translation unit 122, a verifying unit 123, a slice management unit 124, a network database 125, a communication management unit 126, a policy management unit 127, an NOS management unit 128, and an equipment management unit 129. At least one among the units 121-124 and 126-129 may included in a processor.

The interface unit 121, an open application interface unit, may also be referred to as an “Open API”

The interface unit 121 provides a remote procedure call type interface allowing the remote application unit 310 to use a function provided by the NOS 120. For example, the interface unit 121 converts a function provided by the NOS 120 into a REST API form and provides the same to allow the exterior access of the NOS 120 to call a desired function to use it.

The translation unit 122 performs two types of functions. That is, the translation unit 122 translates a request input from the application unit into a form that is easy for an operation, or may translate process results with respect to a request into a form that is processable by the application unit. The translation unit 122 operates in association with the verifying unit 123 and the interface unit 121, and in order to check whether a request from the application unit negatively affects a network managed by the NOS 120 or an internal state of the NOS 120, the translation unit 122 may translate the request into a form to be easily verified (e.g., an intermediate language), and provide the same to the verifying unit 123. Also, verification operation results of the verifying unit 123 are translated into a form that is processable in the application unit. When the request has been provided from the remote application unit 310, the translation unit 122 may translate the verification operation results into an open API form and provide the same to the remote application unit 310.

The verifying unit 123 may be referred to as a native verifier, and may verify whether a request input from an external application unit (the remote application, native application unit, and the like) is in conflict with a current NOS state and a network configuration and properties managed by the NOS in the NOS 120. Information regarding a network state used for verification is stored in the network database 125, and the verifying unit 123 performs a verification operation with reference to the network database 125.

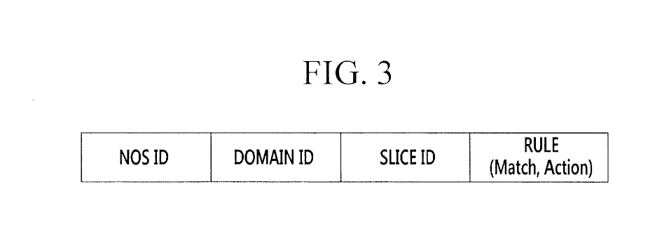

The network database 125 stores the information regarding the network state and a state of the network equipment currently managed by the NOS. For example, values such as topology information, link state information, a flow rule, other statistical information, a current property, and the like, are stored. Information which is frequently used and guaranteed for a fast response speed may be stored and managed in a form of an in-memory database of key-value pairs. Complicated information may be expressed by an intermediate language used by the translation unit 122 and the verifying unit 123. Slice, flow, and domain information may be stored and managed in such a format as illustrated in FIG. 3.

FIG. 3 is a view illustrating an information format stored in a network database according to an embodiment of the present invention.

In accordance with IDs of NOSs, slice IDs and domain IDs with respect to managed virtual networks and various relevant rules (match, action rules, and the like) may be stored and managed. A request from an application unit may be divided and processed by slice on the NOS basis, and stored and managed in such a format as illustrated in FIG. 3.

Meanwhile, the slice management unit 124 divides a request from an application unit by slice and processes the same. The NOS 120 divides a single physical network into several virtual networks and provides the same by using a network virtualization technology, as well as a physical connection state provided by network equipment of a lower layer, and the virtual networks may be divided by slice. Thus, network views of each NOS user may be different, and although a plurality of users are connected to the same physical network, it can be guaranteed that the plurality of users do not interfere with each other.

The slice management unit 124 allocates the request input from an application unit to one of the plurality of virtual networks to allow the corresponding request to be processed on the basis of a slice ID corresponding to the virtual network to which the request was allocated.

The communication management unit 126 performs a function of processing mutual synchronization with a standard network stack. The NOS 120 communicates with an application unit thereabove, a programmable switch therebelow, and the remote application unit 310 or any other NOS on the same layer, and is mutually synchronized with a standard network stack required for the communication.

The policy management unit 127 defines a new policy, and reflects the policy in network configuration. When a particular policy is generated in configuring a network, the policy management unit 127 manages the corresponding policy in an intermediate language provided from the translation unit 122 and the verifying unit 123 to allow a property of the policy to be verified, and utilizes the verified property in defining a new policy. A relevant policy may be defined, verified, and referred to through a virtual network or an application involving different domains, and through the policy management unit 127 when NOS related calculation is processed. Also, when a virtual network and an external domain interwork, a relevant policy may be defined, verified, and referred to through the policy management unit 127.

The NOS management unit 128 may manage connectivity between one NOS and another NOS, and may be referred to as an inter-NOS management unit. One NOS may communicate with another NOS in the same manner as that of an application unit. In this case, when fault-tolerance is guaranteed without logically separating a relationship with a different NOS, or when a single domain is managed by several NOSs in order to distribute a load of the NOSs, the NOS management unit 128 manages NOS batch information regarding a plurality of NOSs related to the same domain. In order to guarantee stability, NOSs may be connected in a chain form to define NOS batch information such that when NOS #1 has a fault, NOS #2 may perform processing instead. Also, when two NOSs are connected to the same domain, NOS batch information may be generated and managed such that operations of the two NOS may be halved to be performed.

The equipment management unit 129 manages various network equipment including the programmable switches connected to the NOS 120. The equipment management unit 129 manages a name of the equipment, a property of the equipment, current state information regarding the network equipment, and the like, and may store information to be managed continuously in the network database 125.

Meanwhile, the NOS 120 having such a structure may be classified into an intra-domain NOS 410 and an inter-domain NOS 420. A domain is a network region divided on the basis of a management subject. For example, an overall network of a company may be a single domain, domains may be individually assigned by building or floor, or a domain may be divided on the basis of service providers or various policy levels including billing. The intra-domain NOS 410 operates over several domains that may be managed by a current user, and the inter-domain NOS 420 only operates over a current domain. When a single NOS operates over several domains, a corresponding NOS operates after a policy is verified through a policy management unit and a verifying unit of each NOS.

Meanwhile, the reliability checking device 110 performs verification on a function itself defined by an application unit. For example, when match-action rules are input over a particular open flow programmable switch among a plurality of pieces of network equipment through an application unit, whether inter-contradiction exists between rules, whether an infinite loop or a black hole is generated in a structure designated by an application, and the like, are required to be verified.

When a property to be verified is related to an internal state of the NOS, the reliability checking device 110 may use a function provided by the verifying unit 123 of the NOS. Unlike the verifying unit 123, the reliability checking device 110 may be connected to the NOS 120 by a remote procedure call interface such as REST, or the like, so it may interwork with a particular NOS in an independent manner. Thus, the reliability checking device 110 may process a verification operation on specific programming implementing the application unit or the NOS in an independent manner, and to this end, it may provide a mutual translation function between a specific input language and a remote procedure call such as JSON-PRC, or the like.

Hereinafter, an operation of the system for controlling and verifying a network according to an embodiment of the present invention on the basis of the structure will be described.

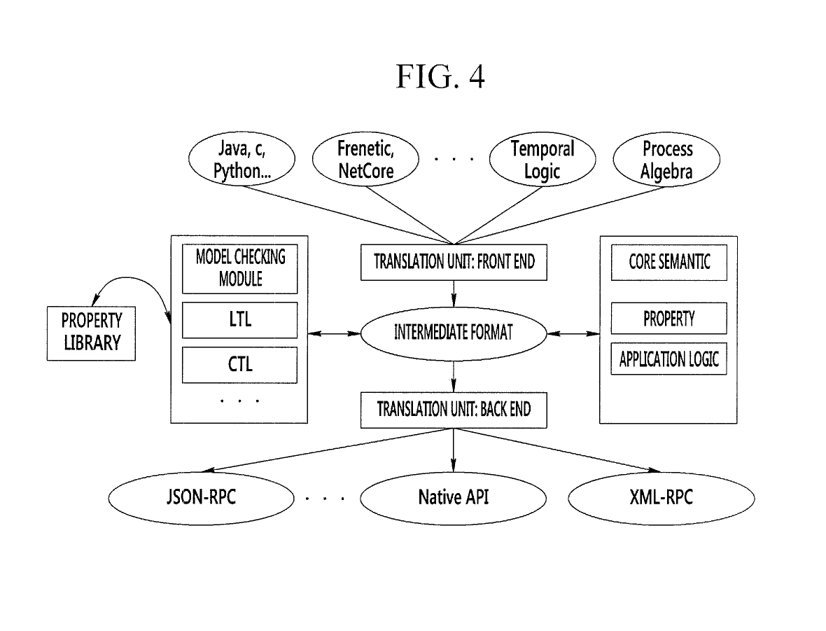

FIG. 4 is a view structurally illustrating operations of a reliability checking device and a verifying unit performing a verification process in the system for controlling and verifying a network according to an embodiment of the present invention.

In the system 100 for controlling and verifying a network according to an embodiment of the present invention, a verification process is performed in the reliability checking device 110 and the verifying unit 123 of the NOS 120, and a commonly performed verification process is illustrated in FIG. 4.

Input languages with respect to data input to the reliability checking device 110 and the verifying unit 123 of the NOS may be divided into two types of languages. One is a language denoting an operation itself, i.e., an operation denoting language, defined by an application unit or the like, and the other is a language denoting a property, i.e., a property denoting language, which should be satisfied in such an operation. Thus, input data is operation information denoted in the operation denoting language and property information denoted in the property denoting language.

The operation denoting language includes languages ranging from general-purpose programming languages such as Java, C, and Python, to domain specific languages (DSL) such as Frenetic specified for SDN/OpenFlow, NetCore, and the like. The property denoting language includes a temporal logic-based language capable of expressing the order of operations and temporal relationships, a process algebra-based language, and the like. The verifying unit 123 may receive property information denoted in the property denoting language, as an option. The reason why the property information is provided in the form of an option is that, if a property desired to be verified is so common that it is provided to an internal library (e.g., a loop, a black hole, and the like), its property is not required to be designated, and although only operation information is input, it can be internally verified.

Operation information and property information expressed in two types of language are translated into intermediate languages through the translation unit 122. At this time, the intermediate languages are based on formal semantics defined for an SDN environment. A property or an operation may be verified with an existing model checking device by using a binary decision diagram (BDD)-based data structure. Alternatively, a property or an operation may be expressed in a long term support (LTS) manner and applied to a process algebra-based language. Various properties are verified on the basis of the thusly translated operation information or property information of intermediate languages, and the verification results are again translated into a form appropriate for various interfaces through the translation unit 122.

To perform the foregoing process, the reliability checking device 110 and the verifying unit 123 of the NOS 120 may include a model checking module 10 performing verification of operation information or property information translated into the intermediate languages, and may further include a property library 11 as a property storage in which pieces of information as basic data for verification are stored. The verification results are translated by the translation unit 122 through various interfaces and returned to an object which has requested the verification. Here, as illustrated in FIG. 4, the translation unit 122 may be implemented as a front end-type translation unit and a back end-type translation unit to translate the input request into an intermediate format appropriate for a verification operation, so as to allow the request to be verified accordingly, and translates the verification results through various interfaces and return the same.

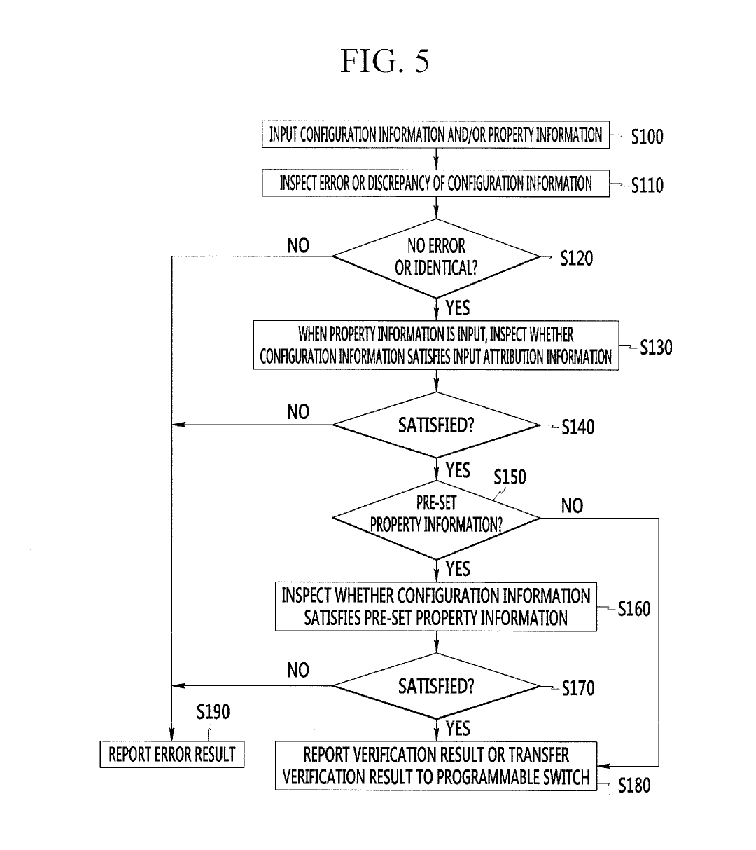

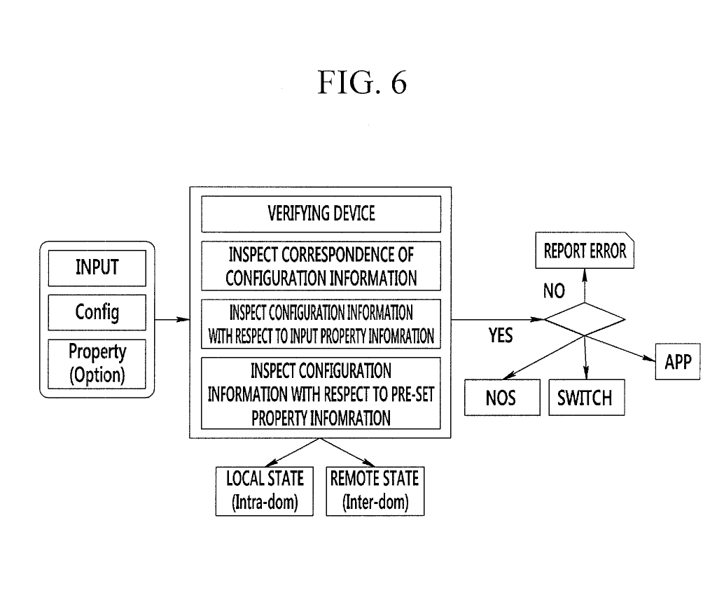

FIG. 5 is a flowchart illustrating a verification method according to an embodiment of the present invention, and FIG. 6 is a view illustrating operations of the reliability checking device and the verifying unit in performing the verification method according to an embodiment of the present invention.

A verifying method as illustrated in FIG. 5 may be performed through the reliability checking device and the verifying unit, and here, for description purposes, the reliability checking device and the verifying unit will be integrally referred to as a “verifying device”. The verification order illustrated in FIG. 5 is merely an example based on the verifying method according to an embodiment of the present invention, and the present inventive concept is not limited thereto.

First, configuration information including a network operation and a configuration matter and property information to be satisfied in the configuration information are input (S100). The verifying device receives the configuration information and the property information, and in this case, commonly used property information may not be designated. That is, property information input for verification may not include generally commonly used property information.

The verifying device inspects whether there is an error in the configuration itself or whether they do not correspond to each other, on the basis of the input information (S110 and S120). For example when two match-action rules with respect to an open flow switch conflict with each other or are configured to form an infinite loop, the corresponding rules are filtered out.

When property information is input for verification, the verifying device inspects whether the configuration information satisfies the input property information (S130).

Further, although not input, on the basis of pre-set property information (for example, properties that should always be satisfied regardless of configuration information, properties which are frequently used and stored in the property library, and the like, and in this case, the properties stored in the property library may include all the properties that do not conflict in a loop or a rule or related to configuration of a network, such as an access control with respect to a particular packet, or the like), the verifying device may additionally inspect whether the configuration information satisfies the property information (S140 to S160).

Such a verification process may be performed only with input configuration information or property information, or may be performed in consideration of additional separate information. In many cases, the network information and state currently managed by the NOS are affected by the NOS itself. For example, a rule of a newly input switch flow may damage an existing network state, so such information is required to be inspected. Such information may refer to state information (a local state or a remote state) provided by the NOS. The network database 125 may store the state information, and the verifying device may perform an additional verifying process to inspect whether the configuration information satisfies the state information with reference to the state information of the network database 125. Alternatively, the verifying device may perform an additional verifying process to check whether configuration information has been changed or whether it satisfies information regarding a new policy or newly added equipment.

The results of the verifying process performed by the verifying device are transferred to the application unit, the NOS, and the programmable switch. For example, when verification is performed on a matter called by the remote application unit 310 or the external NOS, the reliability checking device performs the foregoing verifying process and reports the verification results to the remote application unit or the external NOS. Meanwhile, when the verifying unit 123 of the NOS 120 performs verification on the matter called by the application unit, the external NOS, or the like, if there is no error according to the verification results, the verifying unit 123 may immediately transfer the verification results to the programmable switch 200 as network equipment of a lower layer.

In detail, as illustrated in FIGS. 5 and 6, the verifying device generates a verification result report including verification results of respective steps and transfers the report to the application, the external NOS, or the like, which has requested verification, while providing the corresponding information, and when there is no error, the verifying device transfers the verification results including the input configuration information and/or property information to the programmable switch 200 (S170 and S180). Meanwhile, when an error occurs because the configuration information does not satisfy the corresponding property information when performing inspection in each step, the verifying device generates an error result report and transfers the report to the application unit, the external NOS, or the like, which has requested verification (S190). When an error is found, the verification results may be translated into a form appropriate for various interfaces through the translation unit 122 and transferred to the application unit or the NOS.

According to an embodiment of the present invention, in an environment in which heterogeneous equipment interwork through an open interface, an error that may occur in reliably defining a network operation can be easily detected.

Also, in a software defined network environment, verification is performed such that a problem does not arise in a network due to an unintended error when a user defines a network configuration or function, whereby, while maintaining the advantages of a software defined network in which pieces of heterogeneous equipment interwork through an open interface, shortcomings not provided by a current software defining network technology can be complemented to significantly enhance utilization and dependence of the software defined network.

The embodiments of the present invention may not necessarily be implemented only through the foregoing devices and methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for verifying a network operation by a system in a network environment in which heterogeneous types of network equipment interwork, the method comprising:
receiving, by the system, a request including network operation-related configuration information regarding at least one piece of network equipment included in a single domain, in a state in which the network equipment is managed by a domain;
to verifying, by the system, whether the request is in conflict with a network configuration and property managed by the system; and
when an error has not occurred according to the verification results, transferring the verification results including the configuration information to the network equipment.

2. The method of claim 1, wherein
in the receiving, the request is received from an application of a higher layer or an external network operation system (NOS), and
in the transferring, the verification results are transferred to the application unit or the external NOS.

3. The method of claim 2, further comprising:
translating the input request into a configuration form for verification before the verifying; and
translating the verification results into a form that is processable in the application unit or the external NOS before the transferring.

4. The method of claim 2, wherein the configuration information is information regarding a software defined network (SDN) to control network equipment included in the domain by the application unit of the higher layer or the external NOS, and the SDN is one of a plurality of virtual networks obtained by classifying a physical network to which pieces of network equipments are connected, by slice.

5. The method of claim 4, further comprising
allocating the input received by one of the plurality of virtual networks so that the corresponding request can be processed on the basis of a slice ID corresponding to the virtual network to which the request was allocated, after the receiving.

6. The method of claim 4, wherein in the verifying, the configuration information includes match-action rules with respect to network equipment included in a domain related to the SDN and information regarding a structure of the SDN, and
the verifying comprises verifying whether inter-contradiction exists between the rules or whether an infinite loop or a black hole is generated in the structure of the SDN.

7. The method of claim 6, wherein
the verifying further comprises,
when the request includes property information in addition to the configuration information,
verifying whether the configuration information satisfies the property information.

8. The method of claim 6, wherein
the verifying further comprises
verifying whether the configuration information satisfies property information previously set by the system.

9. The method of claim 1, wherein,
in the verifying,
the configuration information is verified in consideration of information regarding networks managed by the system and state information regarding the networks.

10. A system for controlling and verifying networks in which pieces of heterogeneous network equipment interwork, the system comprising:
a control device configured to manage the network equipment by domain, classify a physical network to which network equipment is connected into a plurality of virtual networks by slice and manage the same, and control operation of piece of each network equipment; and
a reliability checking device configured to receive configuration information regarding a network operation with respect to at least one piece of network equipment included in a single domain and verify whether the request is in conflict with a network configuration and property managed by the control device,
wherein the request is input from an application unit of a higher layer or an external network operation system (NOS).

11. The system of claim 10, wherein
the control device comprises:
a verifying unit configured to verify whether the request is in conflict with a network configuration and property managed by the control device; and
a translation unit configured to translate the request into a configuration form for verification, provide the same to the verifying unit, and translate verification results from the verifying unit into a form based on an interface corresponding to the application unit or the external NOS.

12. The system of claim 11, wherein
the control device further comprises:
a slice management unit configured to allocate the request to one of a plurality of virtual networks so that the corresponding request can be processed on the basis of a slice ID corresponding to the virtual network to which the request was allocated; and
a network database configured to store information regarding a network state and a network equipment state managed by the control device, the information including at least one of topology information, link state information, and a flow rule,
wherein the information stored in the network database is matched to the slice ID corresponding to the virtual network and a domain ID with respect to network equipment related to the corresponding virtual network.

13. The system of claim 11, wherein
at least one of the reliability checking device and the verifying unit operates as a verifying device,
wherein when the configuration information includes match-action rules with respect to network equipment included in a domain related to a software defined network (SDN) and information regarding a structure of the SDN, the verifying device verifies whether intra-contradiction exists between the rules or whether an infinite loop or a black hole is generated in the structure of the SDN.

14. The system of claim 13, wherein when the request includes property information in addition to the configuration information, the verifying device additionally verifies whether the configuration information satisfies the property information.

15. The system of claim 13, wherein the verifying device comprises a property library storing property information previously set by the system, and additionally verifies whether the configuration information satisfies the property information previously set by the system.

16. The system of claim 10, wherein the network equipment is a programmable switch.
